(19) United States
(12) Patent Application Publication
(10) Pub. No.: US 2003/0089742 A1
(43) Pub. Date: May 15, 2003

(54) Steel container, especially intended for the transport of bulk goods

(76) Inventor: Bas Fons, De Zaan (NL)

Correspondence Address: YOUNG & THOMPSON, 745 SOUTH 23RD STREET 2ND FLOOR, ARLINGTON, VA, 22202

(21) Appl. No.: 10/149,183

(22) PCT Filed: Dec. 8, 2000
(86) PCT No.: PCT/NL00/00909

(30) Foreign Application Priority Data
Dec. 8, 1999 (NL) 1013796

(51) Int. Cl. B67D 5/06

(52) U.S. Cl. 222/185.1

(57) ABSTRACT

Inside a steel container (1, 17, 23), a bin (3) of corrosion-resistant material is fitted. This bin (3) is fastened to the container walls. The side walls and the top wall of the bin are substantially identical in shape to those of the steel container. The container is intended for the transport of bulk goods, especially plastics particle material, the contamination of this material by steel particles, which have come loose as a result of corrosion, being prevented.

The invention relates to a steel container, especially intended for the storage and transport of bulk goods.

Transport of plastics particle material in steel ISO containers or steel high-cube containers produces problems if the plastics particles come into direct contact with the steel inner surfaces of the container walls. Steel particles which come loose as a result of corrosion of these walls are extremely damaging to the extruder in which the plastics particle material is processed, whilst, moreover, the product emerging from the extruder will be of relatively low quality. The customary solution to this problem is to hang up a large plastics sack (inner liner) in the container and to feed the plastics particles into this. This solution exhibits a number of drawbacks. The fitting of a sack in a container, the filling of the sack and the emptying thereof is time-consuming. Moreover the sacks are difficult to empty fully, so that material is left behind. In order to keep the sacks in place as the container is tipped, a frame (bulkhead) is erected, which can consist of wood and/or cardboard and/or steel tubular profiles. These materials have to be removed, which can cause a problem. Sometimes the sacks tear, so that steel particles emanating from the container manage, after all, to find their way into the plastics material. The sacks are used once and thrown away, including the plastics granules remaining therein, which is bad for the environment and entails costs.

The object of the invention is to avoid the abovementioned problems with the transport of plastics particle material or other bulk material in containers, without experiencing the abovementioned drawbacks.

According to the invention, the steel container specified in the introduction is, to this end, characterized in that, inside the steel container, a bin which is made from corrosion-resistant material and is fastened to this container is fitted, the side walls and the top wall of which are substantially identical in shape to those of the steel container. As the corrosion-resistant material, stainless steel and hard plastic (including composite) enter into consideration, though an aluminium alloy, for example an aluminium magnesium alloy, is preferable owing to the low price and low weight and the excellent anti-corrosive properties.

The transportation of solid plastics in the containers according to the invention, for example from the plastic producer to the processing plant, yields a positive environmental effect. The plastic remains pure. There is no loss of plastic. Both the steel walls of the container and the corrosion-resistant bin inside the container are recyclable.

In order to connect together the steel container walls and the walls of corrosion-resistant material, the fastening between the steel container walls and the walls of corrosion-resistant material can be formed by a bushing inserted through a mutually aligned opening in both walls and in which the screw bolt is turned, which bushing is deformed into an annular thickening lying against the outer side of the steel wall. Such a connection is denoted by the term blind rivet nut.

Normally, the steel container will be an ISO container or high-cube container having at least one door on a short side, that wall (bulkhead) of the bin of corrosion-resistant material which is situated close to the door or doors of the steel container being provided with a discharge opening close to the floor, which discharge opening can be closed off by a valve, and a manhole close to the roof and at least one inspection glass.

The container can have a floor in the form of a number of funnels having an outlet opening which can be closed off by a valve.

In order to be able filly to empty a tilted container according to the invention, it is preferable if, over those corners of the bin of corrosion-resistant material which are situated close to the discharge opening, angled partitions are fitted, which, as the bin is emptied, conduct the bulk material towards the discharge opening.

At least the transitions from the long side walls into the top wall and from a short side wall into the top wall and the long side walls preferably comprise angled or rounded parts, which are welded at their bent-over flat ends to the vertical and horizontal walls of the bin.

The internal bin of corrosion-resistant material must regularly be cleaned. This can easily be realized if a water pipe having spray openings emerging in the bin of corrosion-resistant material is moulded onto those angled or rounded corner pieces of the bin of corrosion-resistant material which run in the longitudinal direction of the container.

The invention further relates to a method for storing and transporting bulk material, especially plastics particle material, in containers, in which the bulk material is situated unpacked in the internal bin of a container according to one of the claims.

The invention will be now explained in greater detail with reference to the figures, in which:

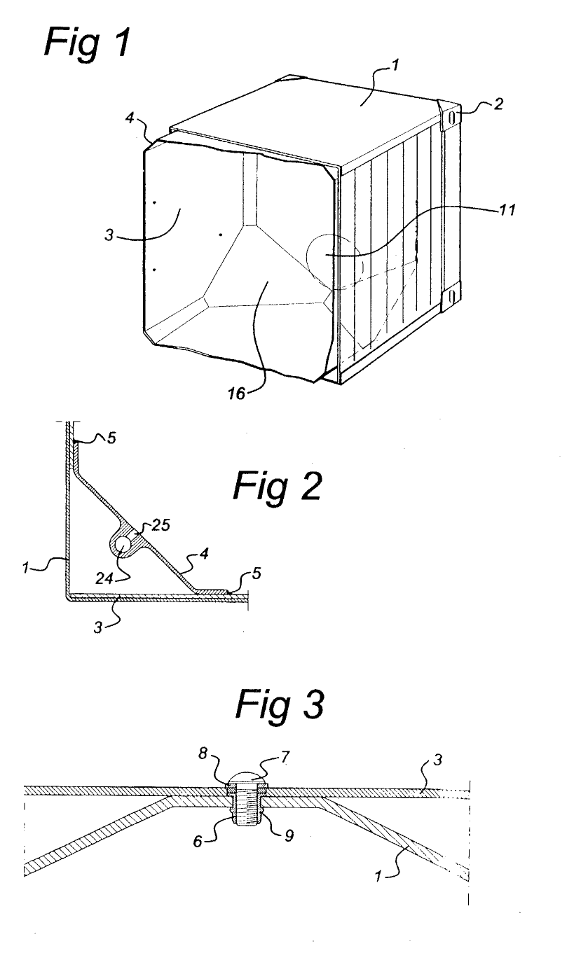

FIG. 1 shows a perspective view of a portion of an ISO container constructed according to the invention,

FIG. 2 shows a cross section through a corner of the container according to FIG. 1,

FIG. 3 shows a cross section through a wall of the container,

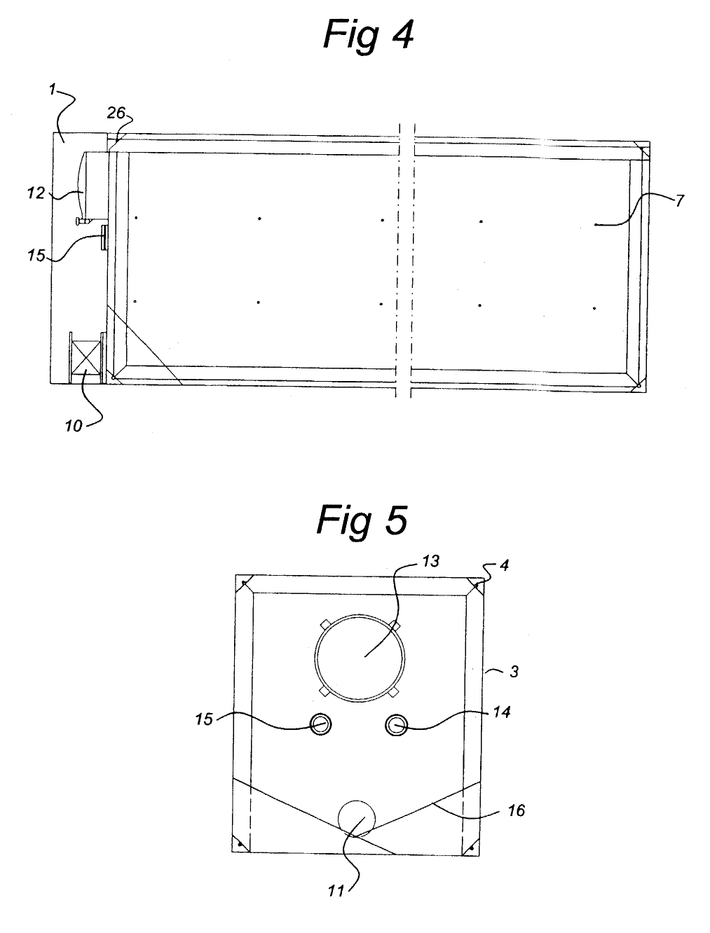

FIG. 4 shows a longitudinal section of the container according to FIGS. 1-3,

FIG. 5 shows a front view of the internal bin of the container according to FIGS. 1-4,

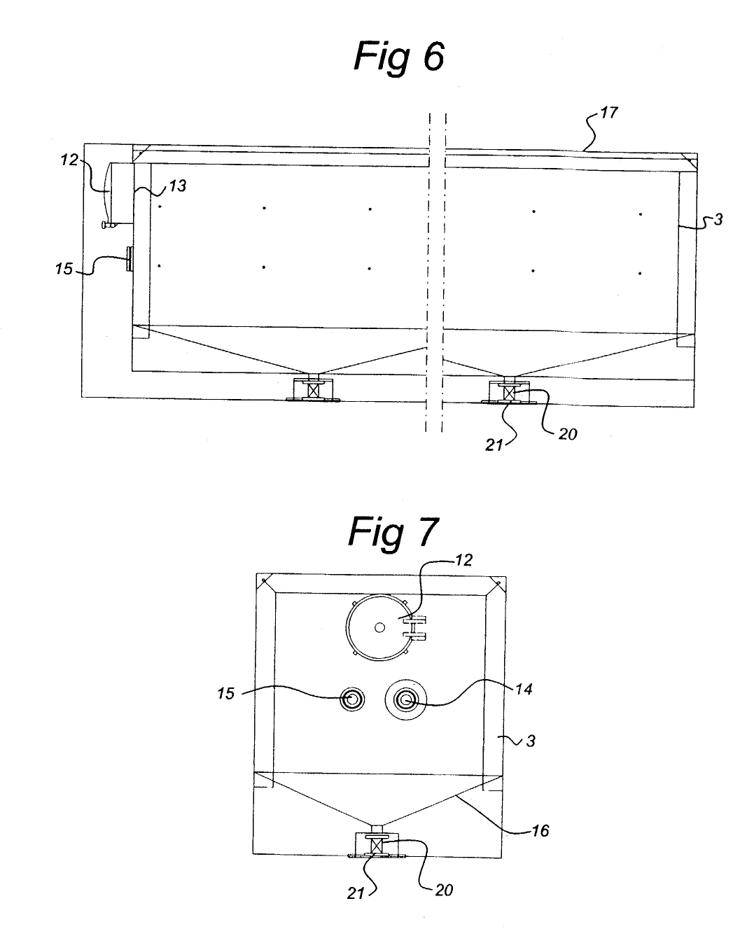

FIG. 6 shows a longitudinal section of a high-cube container according to the invention having a floor consisting of funnel-shaped discharge elements,

FIG. 7 shows a front view of the internal bin of the high-cube container according to FIG. 6.

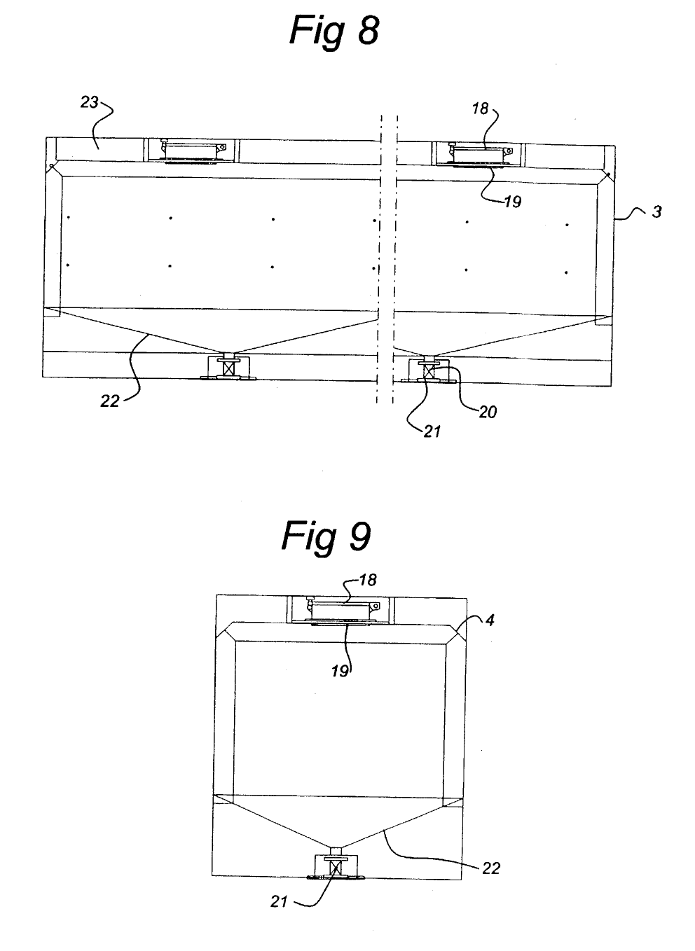

FIG. 8 shows a longitudinal section of an alternative embodiment of a high-cube container according to the invention which differs from that according to FIGS. 6 and 7 by the placement of fill openings in the top wall,

FIG. 9 shows a front view of the internal bin of the container according to FIG. 8.

In FIG. 1, a part of a steel ISO container 1 can be seen. Such containers are used in large numbers in the 20′, 40′, 30′ and 45′ sizes and possess at the comers usual facilities 2 to enable them to be locked to a hoisting trestle or to one another with the aid of twist locks. Inside the ISO container 1, a bin 3 of corrosion-resistant material is fastened, the shape of which substantially conforms to the parallelepipedal shape of the ISO container. Unlike the ISO container, the bin 3 has angled or rounded transition parts 4 at the transitions from an upright long side into the floor and into the top wall; as well as at the transitions from the bin wall, situated close to the thick short side of the container, into the floor and top wall of the bin. These transition parts 4—as shown by FIG. 2—are fastened at bent-over end edges to the walls of the bin 3 by means of a weld joint 5 extending over the length of the wall concerned.

The flat walls of the bin 3 of corrosion-resistant material are fastened to the steel ISO container walls by means of connections, one of which is shown in cross section in FIG. 3. A bushing 6 made from deformable material is inserted through aligned openings in the steel wall of the container and the wall of the corrosion-resistant bin 3 and a screw bolt 7 is screwed through this bushing 6. This bolt 7 presses with its head, via a sealing ring 8, onto the corrosion-resistant material. On the opposite side, the screwed-in bolt has deformed the bushing material in such a way that the thickening 9, which engages the steel wall of the container 1, has been formed. Such a connection is referred to as a blind rivet nut.

The narrow upright wall of the bin 3—the bulkhead, as it is known—which is situated close to the doors of the steel ISO container, is provided with a discharge opening 11 close to the floor of the bin 3, which discharge opening can be closed off by a butterfly valve 10, a manhole 13 close to the top wall of the bin 3, which manhole can be closed off by a hinged door 12, and two inspection holes 14, 15 somewhat below the manhole 13. The bin is filled via the manhole 13, a conveyor belt being able to be introduced temporarily through that manhole in order to bring bulk material, especially plastics particles, into the bin in well-distributed arrangement. The discharging of the bin is realized by tilting the container 1 with bin 3 and opening the butterfly valve 10. At the sites of the opening 11, angled partitions 16 are fitted, which prevent the material to be discharged from being left in the corners of the bin 3.

The bin 3 preferably consists of an aluminium alloy, such as an aluminium magnesium alloy. This material is lightweight, is corrosion-resistant by virtue of the presence of an oxide film on the surfaces and is not unduly expensive. Stainless steel and a hard plastic, including a composite material, are not, however, precluded.

The embodiment according to FIGS. 6 and 7 does not relate to an ISO container, but to a high-cube container 17, in which an internal bin 3 is fitted. This high-cube container with internal bin has a number of discharge openings 21, which can be closed off by a valve 20 and which are situated at the bottom end of funnel-shaped floor parts 22. The internal bin 3 is filled in the same way as the internal bin of the ISO container discussed above, that is to say via a manhole 13, which can be closed off by a door 12, and a conveyor belt, which can be introduced via that manhole. There are also inspection holes 14, 15, which are closed off by glass.

It will be clear that this container does not need to be tilted during discharging, since the material leaves the container via the discharge openings 21. The discharge openings 21 above the floor of the carbon steel container 17 are not precluded from emerging in a horizontal pipe, which is connected to a vacuum appliance for discharging of the bulk material.

The embodiment according to FIGS. 8 and 9 likewise relates to a high-cube container 17, in which an internal bin 3 made of corrosion-resistant material is fitted. This container has on the top side a number of fill openings 19, which can be closed off by a lid 18 and into which plastics material can be fed. As in the container according to FIGS. 6 and 7, discharge openings 21, which can be closed off by a valve 20, are made. These are situated at the bottom end of funnel-shaped floor parts 22.

It is important that the inside of the bin 3 of corrosion-resistant material of the abovementioned containers can easily be cleaned on the inside. To this end, water pipes 24 are moulded onto the angled corner parts 4 of the internal bin 3 of the containers 1, 17 and 23, which water pipes are provided at irregular intervals with spray openings 25, which emerge in the inside of the bin 3. The water pipes 24 are connected by snap couplings 26 (FIG. 4) to a water feed hose (not represented). Various modifications and additions are possible within the scope of the claims.

1. Steel container, especially for the storage and transport of bulk goods, characterized in that, inside the steel container (1, 17, 23), a bin (3) which is made from corrosion-resistant material and is fastened to this container is fitted, the upright side walls and the top wall of which are substantially identical in shape to those of the steel container.

2. Container according to claim 1, characterized in that the said bin (3) of corrosion-resistant material consists of an aluminium alloy.

3. Container according to claim 1, characterized in that the said bin (3) of corrosion-resistant material consists of a hard plastic.

4. Container according to claim 1, characterized in that the said bin (3) of corrosion-resistant material consists of stainless steel.

5. Container according to one of the preceding claims, characterized in that the fastening between the steel container walls and the walls of corrosion-resistant material is formed by a bushing (6) inserted through a mutually aligned opening in both walls and in which a screw bolt (7) is turned, which bushing is deformed into an annular thickening (9) lying against the outer side of the steel wall.

6. Container according to one of the preceding claims, characterized in that the steel container is an ISO standard container or high-cube container having at least one door on a short side, that wall (bulkhead) of the bin of corrosion-resistant material which is situated close to the door or doors of the steel container being provided with a discharge opening (11) close to the floor, which discharge opening can be closed off by a valve, and a manhole (13) close to the roof.

7. Container according to one of claims 1-6, characterized in that the container has a floor in the form of a number of funnels (22) having an outlet opening (21) which can be closed off by a valve (20).

8. Container according to one of the preceding claims, characterized in that over those corners of the bin of corrosion-resistant material which are situated close to the discharge opening (11), angled partitions (16) are fitted, which, as the bin is discharged conduct the bulk material towards the discharge opening (11).

9. Container according to one of the preceding claims, characterized in that at least the transitions from the long side walls into the top wall and from a short side wall into the top wall and the long side walls comprise angled or rounded parts (4), which are welded at their bent-over flat ends to the vertical and horizontal walls of the bin (3).

10. Container according to claim 9, characterized in that a water pipe (24) having spray openings (25) emerging in the bin of corrosion-resistant material is moulded onto those angled or rounded corner pieces (4) of the bin of corrosion-resistant material which run in the longitudinal direction of the container.

11. Method for transporting bulk material, especially plastics particle material, in containers, characterized in that the bulk material is situated unpacked in the internal bin of a container according to one of the preceding claims.
